(19) United States
(12) Patent Application Publication
(10) Pub. No.: US 2017/0277258 A1
(43) Pub. Date: Sep. 28, 2017

(54) METHOD FOR ADJUSTING SCREEN LUMINANCE AND ELECTRONIC DEVICE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Ning MA, Beijing (CN); Xiaoxin ZHANG, Beijing (CN)

(73) Assignees: LE HOLDINGS (BEIJING) CO., LTD., Beijing (CN); LEMOBILE INFORMATION TECHNOLOGY (BEIJING) CO., LTD., Beijing (CN)

(21) Appl. No.: 15/243,283

(22) Filed: Aug. 22, 2016

Related U.S. Application Data
(63) Continuation of application No. PCT/CN2016/089560, filed on Jul. 10, 2016.

(30) Foreign Application Priority Data
Mar. 28, 2016 (CN) 201610183460.1

(51) Int. Cl. G06F 3/01; G09G 5/10

(52) U.S. Cl. CPC G06F 3/013; G09G 5/10; G09G 2360/141; G09G 2354/00

(57) ABSTRACT

Embodiments of the present disclosure relate to the field of display technologies, and disclose a method and device for adjusting screen luminance, and a display device that includes the device for adjusting screen luminance. According to the present disclosure, screen luminance may be adjusted directly according to the eye comfort degree so as to achieve the objective of protecting eyes. The method for adjusting screen luminance includes: detecting a pupil size of a user; and adjusting the screen luminance according to the pupil size, such that the adjusted luminance is in a range within which human eyes are comfortable.

### CROSS-REFERENCE TO RELATED APPLICATIONS

The present disclosure is a continuation of PCT application No. PCT/CN2016/089560 submitted on Jul. 10, 2016. This application is based upon and claims priority to Chinese Patent Application No. 201610183460.1, filed before Chinese Patent Office on Mar. 28, 2016 and entitled “METHOD AND DEVICE FOR ADJUSTING SCREEN LUMINANCE AND DISPLAY DEVICE INCLUDING THE DEVICE”, the entire contents of which are incorporated herein by reference.

### TECHNICAL FIELD

This patent disclosure relates to the field of display technologies, and more particularly, to a method for adjusting screen luminance and an electronic device.

### BACKGROUND

With the development of society and the progresses of science and technologies, smart phones, tablet computers, and the like are increasingly popular. People's life is increasingly dependent upon various types of terminal products including display devices. Moreover, time of using the terminal products each day is gradually increased. Using eyes for a long time easily causes visual fatigue. When eyes stare at a mobile phone screen attentively, constantly changed light shadows on the screen cause continuous stimuli for the eyes; when the eyes ceaselessly capture the light shadows, the eyes are very fatigue. In particular, when a surrounding environment is dark and the mobile phone screen is bright, damages to the eyes are especially big. If things continue this way, problems, for example, impaired vision, or deepened myopia are caused.

To prevent luminance of a mobile phone screen in a case of dark ambient light from causing stimuli and damages to eyes, currently a solution of automatically adjusting screen luminance is equipped on a smart phone; the solution can automatically adjust screen luminance according to an external light source intensity (for example, an ambient light intensity) sensed by a luminance sensor, so as to achieve an objective of adapting the screen luminance to the ambient light intensity, thereby reducing damages caused by a too-bright mobile phone screen in a dark environment to human eyes.

However, actually, adaptabilities of eyes of each person to different light intensities are different; if an adjusting manner of automatically adjusting screen luminance according to the ambient light intensity is uniformly used, consequently, some people may benefit from the adjusting manner, and their eyes are effectively protected; however, some other people which have different light intensity adaptabilities may not enable their eyes to be protected, and even their eyes may be hurt.

### SUMMARY

To overcome the defect that the existing solution of automatically adjusting screen luminance cannot be effectively adapted to all users, the present disclosure provides a method and device for adjusting screen luminance and a display device that includes the device for adjusting screen luminance. According to the present disclosure, screen luminance may be adjusted directly according to the eye comfort degree so as to achieve the objective of protecting eyes.

With the above technical solutions, some embodiments of the present disclosure provide a method for adjusting screen luminance. The method includes: detecting a pupil size of a user; and adjusting the screen luminance according to the pupil size, such that the adjusted luminance is in a range within which human eyes are comfortable.

In one embodiment, the adjusting the screen luminance according to the pupil size may include: comparing the pupil size with a pupil size conversion range table, where the pupil size conversion range table stores a correspondence between luminance and a pupil size of human eyes under the luminance; determining whether luminance corresponding to the pupil size is in the range within which human eyes are comfortable; and when the luminance is not in the range within which human eyes are comfortable, adjusting the screen luminance to make the adjusted luminance located in the range within which human eyes are comfortable.

In one an embodiment, when the luminance is not in the range within which human eyes are comfortable, adjusting the screen luminance may include: determining whether the luminance is too dark or too bright; and when the luminance is too dark, increasing the screen luminance until the luminance corresponding to the detected pupil size is in the range within which human eyes are comfortable; or when the luminance is too bright, reducing the screen luminance until the luminance corresponding to the detected pupil size is in the range within which human eyes are comfortable.

In one embodiment, after the screen luminance is adjusted, the method may further include: receiving an instruction of the user for adjusting the screen luminance; and adjusting the screen luminance according to the instruction of the user for adjusting the screen luminance.

In one embodiment, the method may further include: associating the screen luminance adjusted according to the instruction of the user for adjusting the screen luminance with an initially detected pupil size, and storing same.

In one embodiment, the adjusting the screen luminance according to the pupil size may include: when the detected pupil size is same as the pupil size on which associative storage is performed, adjusting the screen luminance to the screen luminance on which associative storage is performed.

According to a second aspect, an embodiment of the disclosure further provides a non-transitory computer-readable storage medium, which stores a computer executable instruction, where the computer executable instruction is used to execute any one of the mentioned methods for adjusting screen luminance of this disclosure.

According to a third aspect, an embodiment of the disclosure further provides an electronic device, including: at least one processor; and a memory in communication connection with the at least one processor. The memory stores an instruction that can be executed by the at least one processor, and the instruction is executed by the at least one processor, so that the at least one processor can execute any foregoing method for adjusting screen luminance of this disclosure.

According to this disclosure, a human eye iris can be scanned by using an iris technology, so as to determine a pupil size, and screen luminance is adjusted according to the characteristic that miosis occurs in strong light and mydriasis occurs in weak light, so as to enable the screen luminance to satisfy the requirement of the comfort degree of human eyes. Because a pupil has a high sensitivity to light, screen luminance can be enabled to be very accurate. This disclosure can be adapted to people having different light intensity adaptabilities, and enable all of them to benefit from the solution of adjusting screen luminance of this disclosure, thereby ensuring the eye comfort degree when they face a screen of a terminal device.

Other characteristics and advantages of this disclosure are described in detail in a subsequent part of specific implementation manners.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart illustrating a method for adjusting screen luminance according to one embodiment of the present disclosure;

FIG. 2 is a flowchart illustrating a method for adjusting screen luminance according to another embodiment of the present disclosure;

FIG. 3 is a flowchart illustrating a method for adjusting screen luminance according to another embodiment the present disclosure;

FIG. 4 is a schematic structural diagram illustrating a device for adjusting screen luminance according to one embodiment of the present disclosure; and

FIG. 5 is a schematic structural diagram of hardware of an electronic device for executing a method for adjusting screen luminance provided in another embodiment of this disclosure.

### REFERENCE NUMERALS AND DENOTATIONS THEREOF

10 Iris identifying apparatus

20 Luminance adjusting apparatus

30 Associative storage apparatus

### DETAILED DESCRIPTION

Specific embodiments of the present disclosure are described hereinafter in detail with reference to the accompanying drawings. It should be understood that the specific embodiments described hereinafter are merely used for describing and explaining the present disclosure, and are not intended to limit the present disclosure.

Before the specific embodiments of the present disclosure are introduced in detail, some of general knowledge, which is involved in the present disclosure, of a pupil of eye is introduced first. A pupil is a small circular hole at the center of an iris in a human eye, and is a channel through which light enters the eye. Extension and retraction of smooth muscles on the iris can make a caliber of the pupil to be reduced or enlarged, thereby controlling an amount of light that enters the pupil. Generally, a diameter of the pupil of a human eye can vary between 1.5 and 8.0 mm. Suppose a person enters a dark room from a bright place, a diameter of a pupil thereof can increase 5 times, and then a light receiving area of the pupil increases 25 times, thereby ensuring that an amount of light that enters the pupil satisfies visual requirements of the person. Therefore, variation of a pupil size has a function of keeping an amount of light that enters an eye under different illumination conditions constant. The present disclosure is provided according to a correspondence between a pupil size and luminance, such that screen luminance adjusted according to the correspondence can satisfy the requirement of the comfort degree of human eyes.

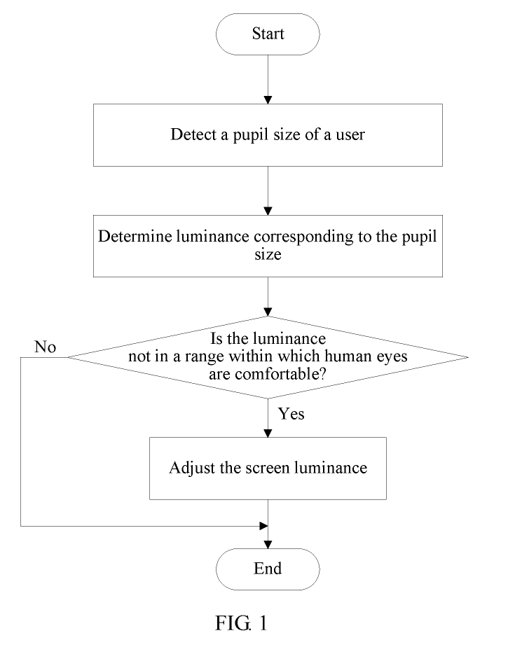

FIG. 1 is a flowchart illustrating a method for adjusting screen luminance according to one embodiment of the present disclosure. As illustrated in FIG. 1, the present disclosure provides a method for adjusting screen luminance. The method includes: detecting a pupil size of a user; and adjusting the screen luminance according to the pupil size (for example, an iris diameter), such that the adjusted luminance is in a range within which human eyes are comfortable.

Specifically, the adjusting the screen luminance according to the pupil size may include: comparing the pupil size with a pupil size conversion range table, where the pupil size conversion range table stores a correspondence between luminance and a pupil size of human eyes under the luminance; determining whether luminance corresponding to the pupil size is in the range within which human eyes are comfortable; and when the luminance is not in the range within which human eyes are comfortable, adjusting the screen luminance to make the adjusted luminance located in the range within which human eyes are comfortable. It should be noted herein that the luminance stored in the pupil size conversion range table cannot be completely equal to the screen luminance, instead, is luminance with which human eyes are directly faced (factors, for example, ambient light may exist); and the pupil size of human eyes under the luminance may be taken from an average value of pupil sizes of multiple people under the luminance. Certainly, the luminance stored in the pupil size conversion range table and the pupil size of human eyes under the luminance may not be a specific single value, instead, may be a range, for example, a luminance range and pupil sizes corresponding to each other.

The pupil size conversion range table, for example, may store the following content:

(LIGHT1, M1),

(LIGHT2, M2),

(LIGHT3, M3),

. . . ,

(LIGHTn, M4),

LIGHT1, LIGHT2, LIGHT3, . . . , LIGHTn indicate different luminances or luminance ranges; M1, M2, M3, . . . , Mn respectively indicate pupil sizes of human eyes under the luminances LIGHT1, LIGHT2, LIGHT3, . . . , LIGHTn; the pupil size may be an average value of pupil sizes of multiple people under corresponding luminance, and may be also a pupil size range. The range within which human eyes are comfortable refers to a range of luminances, with which human eyes are faced in a comfortable state; the range within which human eyes are comfortable may be obtained by testing and investigating different kinds of people.

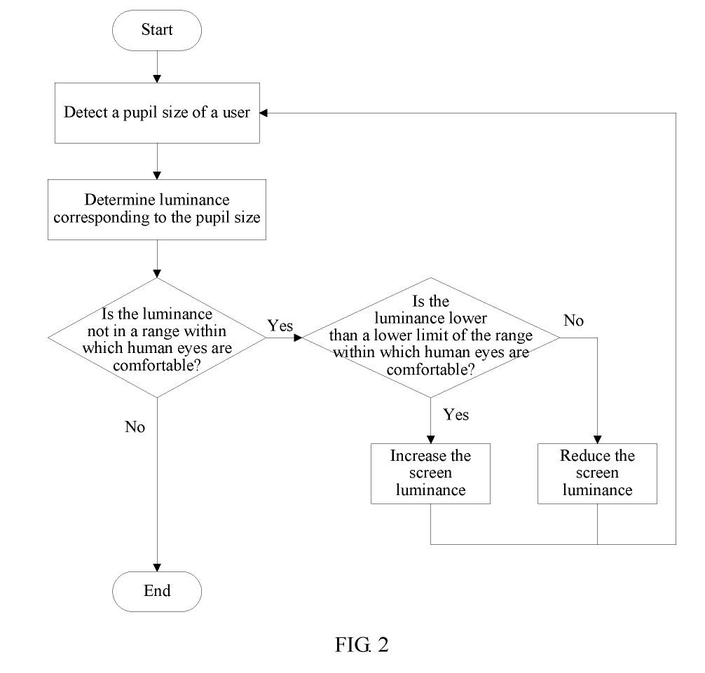

FIG. 2 is a flowchart illustrating a method for adjusting screen luminance according to another embodiment of the present disclosure. As illustrated in FIG. 2, when the luminance is not in the range within which human eyes are comfortable, the adjusting the screen luminance may include: determining whether the luminance is too dark or too bright, for example, determining whether luminance corresponding to a current pupil size is lower than a lower limit of a range within which human eyes are comfortable or higher than an upper limit of the range within which human eyes are comfortable. When the luminance corresponding to the current pupil size is lower than the lower limit of the range within which human eyes are comfortable, it may be determined that the luminance is too low, and in this case, the screen luminance may be increased, and the pupil size is constantly detected in a period of increasing the screen luminance, and luminance corresponding to the pupil size is determined; the operation of increasing luminance is continued until the luminance corresponding to the detected pupil size is in the range within which human eyes are comfortable. When the luminance corresponding to the current pupil size is higher than the upper limit of the range within which human eyes are comfortable, it may be determined that the luminance is too high, and in this case, the screen luminance may be reduced, and the pupil size is constantly detected in a period of reducing the screen luminance, and luminance corresponding to the pupil size is determined; the operation of reducing luminance is continued until the luminance corresponding to the detected pupil size is in the range within which human eyes are comfortable.

By using a scenario where a user uses a mobile phone in an environment in which ambient light is dark as an example, in an environment in which ambient light is dark, pupils of a user become larger to absorb more light; however, if in this case, the user turns to watch a mobile phone screen, the pupils sharply retract, and become smaller. Therefore, in this case, generally, the user feels that light sent by the mobile phone screen is strong and glaring. In this case, whether the luminance corresponding to the pupil size is in the range within which human eyes are comfortable may be determined according to the reduced pupil size. When the luminance corresponding to the pupil size is higher than the upper limit of the range within which human eyes are comfortable, it may be determined that the luminance is too high, and in this case, the screen luminance may be reduced, and the pupil size is constantly detected in a period of reducing the screen luminance, and luminance corresponding to the pupil size is determined; the operation of reducing luminance is continued until the luminance corresponding to the detected pupil size is in the range within which human eyes are comfortable. In this way, experience of using a mobile phone by the user in the environment in which ambient light is dark may be improved, so as to reduce stimuli of the mobile phone on eyes of the user. A control means adopted when the user uses a mobile phone in an environment in which ambient light is strong of the present disclosure is similar to the above, and the difference lies in increasing the screen luminance until the luminance corresponding to the detected pupil size is in the range within which human eyes are comfortable.

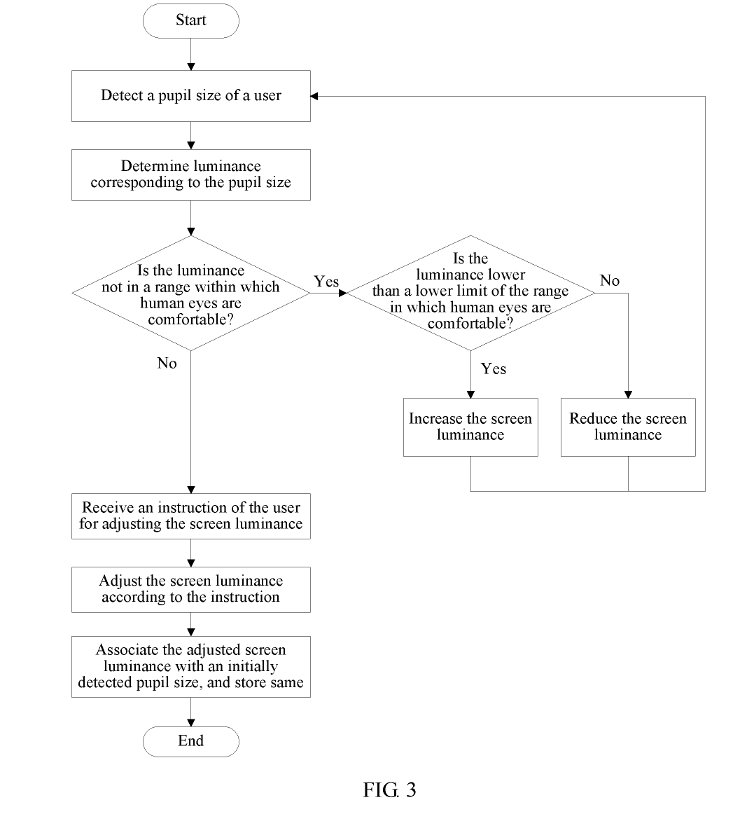

After the screen luminance is adjusted by using the foregoing solution, the user may further perform fine adjustment on the screen luminance to reach a better comfort degree suitable for the user. FIG. 3 is a flowchart illustrating a method for adjusting screen luminance according to another embodiment of the present disclosure. As illustrated in FIG. 3, in an example, the method may further include: receiving an instruction of the user for adjusting the screen luminance; and adjusting the screen luminance according to the instruction of the user for adjusting the screen luminance; after the user adjusts the screen luminance, the screen luminance adjusted according to the instruction of the user for adjusting the screen luminance may be further associated with an initially detected pupil size, and storage is performed. In this way, when the user is in a similar environment next time, the detected pupil size may be directly compared with the pupil size on which associative storage is performed; when the detected pupil size is one of the pupil sizes on which associative storage is performed, the screen luminance corresponding to the pupil size on which associative storage is performed is taken, and the screen luminance is adjusted to the corresponding screen luminance on which associative storage is performed. In this way, a screen luminance adjusting speed may be further improved, and the adjusted screen luminance may be enabled to more satisfy personal requirements of the user.

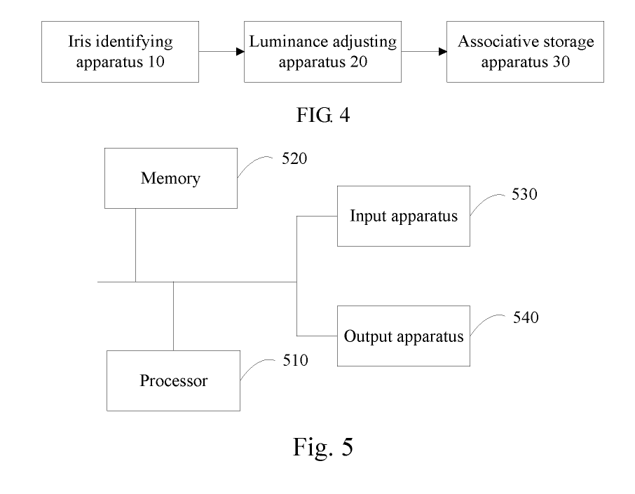

FIG. 4 is a schematic structural diagram illustrating a device for adjusting screen luminance according to one embodiment of the present disclosure. Correspondingly, as illustrated in FIG. 4, the present disclosure further provides a device for adjusting screen luminance, where the device includes: an iris identifying apparatus 10, configured to detect a pupil size of a user; and a luminance adjusting apparatus 20, configured to adjust the screen luminance according to the pupil size, such that the adjusted luminance is in a range within which human eyes are comfortable.

In an example, the adjusting the screen luminance according to the pupil size may include: comparing the pupil size with a pupil size conversion range table, where the pupil size conversion range table stores a correspondence between luminance and a pupil size of human eyes under the luminance; determining whether luminance corresponding to the pupil size is in the range within which human eyes are comfortable; and when the luminance is not in the range within which human eyes are comfortable, adjusting the screen luminance to make the adjusted luminance located in the range within which human eyes are comfortable.

In an example, when the luminance is not in the range within which human eyes are comfortable, adjusting the screen luminance may include: determining whether the luminance is too dark or too bright; and when the luminance is too dark, increasing the screen luminance until the luminance corresponding to the detected pupil size is in the range within which human eyes are comfortable; or when the luminance is too bright, reducing the screen luminance until the luminance corresponding to the detected pupil size is in the range within which human eyes are comfortable.

In an example, after the screen luminance is adjusted, the luminance adjusting apparatus 20 may further perform the following operations: receiving an instruction of the user for adjusting the screen luminance; and adjusting the screen luminance according to the instruction of the user for adjusting the screen luminance.

In an example, the device for adjusting screen luminance may further include: an associative storage apparatus 30, configured to associate the screen luminance adjusted according to the instruction of the user for adjusting the screen luminance with an initially detected pupil size, and store same. In this case, the luminance adjusting apparatus 20 can directly adjust the screen luminance to the screen luminance on which associative storage is performed when the detected pupil size is same as the pupil size, on which associative storage is performed, in the associative storage apparatus 30, thereby improving a screen luminance adjusting speed, and enabling the adjusted screen luminance to more satisfy personal requirements of the user.

Reference may be made to the above description for the method for adjusting screen luminance according to the present disclosure for specific details and benefits of the device for adjusting screen luminance provided in the present disclosure, and thus details are not described herein again.

Correspondingly, the present disclosure further provides a display device. The display device includes the above device for adjusting screen luminance. The display device may involve common devices having a display function in the art, for example, a mobile phone, a notebook computer, a computer, an IPAD, or a television.

According to the embodiments of the present disclosure, the adjusted screen luminance may be enabled to satisfy different requirements of the comfort degree of human eyes, and because a pupil has a high sensitivity to light, the screen luminance may be enabled to be very accurate. The present disclosure may be adapted to people having different light intensity adaptabilities, and enable all of them to benefit from the solution of adjusting screen luminance of the present disclosure, thereby ensuring the eye comfort degree when they face a screen of a terminal device.

Correspondingly, an embodiment of this disclosure provides a non-volatile computer storage medium, which stores a computer executable instruction, where the computer executable instruction can execute the method for adjusting screen luminance in any one of the foregoing method embodiments.

Correspondingly, FIG. 5 is a schematic structural diagram of hardware of an electronic device for adjusting screen luminance provided in another embodiment of this disclosure. As shown in FIG. 5, the device includes: one or more processors 510 and a memory 520, where only one processor 510 is used as an example in FIG. 5.

A device for executing the method for adjusting screen luminance may further include: an input apparatus 530 and an output apparatus 540.

The processor 510, the memory 520, the input apparatus 530, and the output apparatus 540 can be connected by means of a bus or in other manners. A connection by means of a bus is used as an example in FIG. 5.

As a non-transitory computer-readable storage medium, the memory 520 can be used to store non-volatile software programs, non-volatile computer executable programs and modules, for example, a program instruction/module corresponding to the method for adjusting screen luminance in the embodiments of this disclosure (for example, the iris identification apparatus 10, the luminance adjusting apparatus 20, and the associative storage apparatus 30 shown in FIG. 3). The processor 510 executes various functional disclosures and data processing of the server, that is, implements the method for adjusting screen luminance of the foregoing method embodiments, by running the non-transitory software programs, instructions, and modules that are stored in the memory 520.

The memory 520 may include a program storage area and a data storage area, where the program storage area may store an operating system and an disclosure that is needed by at least one function; the data storage area may store data created according to use of the apparatus for adjusting screen luminance, and the like. In addition, the memory 520 may include a high-speed random access memory, or may also include a non-transitory memory such as at least one disk storage device, flash storage device, or other non-transitory solid-state storage device. In some embodiments, the memory 520 optionally includes memories that are remotely disposed with respect to the processor 510, and the remote memories may be connected, via a network, to the apparatus for adjusting screen luminance. Examples of the foregoing network include but are not limited to: the Internet, an intranet, a local area network, a mobile communications network, or a combination thereof.

The input apparatus 530 can receive entered digits or character information, and generate key signal inputs relevant to user setting and functional control of the apparatus for adjusting screen luminance. The output apparatus 540 may include a display device, for example, a display screen.

The one or more modules are stored in the memory 520; when the one or more modules are executed by the one or more processors 510, the method for adjusting screen luminance in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. A method for adjusting screen luminance, applied in a terminal, comprising:
detecting a pupil size of a user; and
adjusting the screen luminance according to the pupil size, such that the adjusted luminance is in a range within which human eyes are comfortable.

2. The method according to claim 1, wherein the adjusting the screen luminance according to the pupil size comprises:
comparing the pupil size with a pupil size conversion range table, wherein the pupil size conversion range table stores a correspondence between luminance and a pupil size of human eyes under the luminance;
determining whether luminance corresponding to the pupil size is in the range within which human eyes are comfortable; and
when the luminance is not in the range within which human eyes are comfortable, adjusting the screen luminance to make the adjusted luminance located in the range within which human eyes are comfortable.

3. The method according to claim 1, wherein when the luminance is not in the range within which human eyes are comfortable, the adjusting the screen luminance comprises:
determining whether the luminance is too dark or too bright; and
when the luminance is too dark, increasing the screen luminance until the luminance corresponding to the detected pupil size is in the range within which human eyes are comfortable; or
when the luminance is too bright, reducing the screen luminance until the luminance corresponding to the detected pupil size is in the range within which human eyes are comfortable.

4. The method according to claim 1, wherein after the screen luminance is adjusted, the method further comprises:
receiving an instruction of the user for adjusting the screen luminance; and
adjusting the screen luminance according to the instruction of the user for adjusting the screen luminance.

5. The method according to claim 1, wherein the method further comprises:
associating the screen luminance adjusted according to the instruction of the user for adjusting the screen luminance with an initially detected pupil size, and storing same.

6. The method according to claim 1, wherein the adjusting the screen luminance according to the pupil size comprises:
when the detected pupil size is same as the pupil size on which associative storage is performed, adjusting the screen luminance to the screen luminance on which associative storage is performed.

7. A non-volatile computer storage medium, which stores a computer executable instructions, wherein the computer executable instruction is set as:
detecting a pupil size of a user; and
adjusting the screen luminance according to the pupil size, so that the adjusted luminance is in a range in which human eyes are comfortable.

8. The non-transitory computer-readable storage medium according to claim 7, wherein the adjusting the screen luminance according to the pupil size comprises:
comparing the pupil size with a pupil size conversion range table, wherein the pupil size conversion range table stores a correspondence between luminance and a pupil size of human eyes under the luminance;
determining whether luminance corresponding to the pupil size is in the range in which human eyes are comfortable; and
in a case in which the luminance is not in the range in which human eyes are comfortable, adjusting the screen luminance to make the adjusted luminance located in the range in which human eyes are comfortable.

9. The non-transitory computer-readable storage medium according to claim 7, wherein in a case in which the luminance is not in the range in which human eyes are comfortable, adjusting the screen luminance comprises:
determining whether the luminance is too dark or too bright; and
in a case in which the luminance is too dark, increasing the screen luminance until the luminance corresponding to the detected pupil size is in the range in which human eyes are comfortable; or
in a case in which the luminance is too bright, reducing the screen luminance until the luminance corresponding to the detected pupil size is in the range in which human eyes are comfortable.

10. The non-transitory computer-readable storage medium according to claim 7, wherein after the screen luminance is adjusted, the method further comprises:
receiving an instruction of the user for adjusting the screen luminance; and
according to the instructions of the user for adjusting the screen luminance, adjusting the screen luminance.

11. The non-transitory computer-readable storage medium according to claim 7, wherein the non-volatile computer storage medium further comprises:
associating the screen luminance adjusted according to the instruction of the user for adjusting the screen luminance with an initially detected pupil size, and storing same.

12. The non-transitory computer-readable storage medium according to claim 7, wherein the adjusting the screen luminance according to the pupil size comprises:
in a case in which the detected pupil size is same as the pupil size on which associative storage is performed, adjusting the screen luminance to the screen luminance on which associative storage is performed.

13. An electronic device, comprising:
at least one processor;
and a memory communicably connected with the at least one processor for storing instructions executable by the at least one processor, where execution of the instructions by the at least one processor causes the at least one processor to be capable of:
detecting a pupil size of a user; and
adjusting the screen luminance according to the pupil size, so that the adjusted luminance is in a range in which human eyes are comfortable.

14. The electronic device according to claim 13, wherein the adjusting the screen luminance according to the pupil size comprises:
comparing the pupil size with a pupil size conversion range table, wherein the pupil size conversion range table stores a correspondence between luminance and a pupil size of human eyes under the luminance;
determining whether luminance corresponding to the pupil size is in the range in which human eyes are comfortable; and
in a case in which the luminance is not in the range in which human eyes are comfortable, adjusting the screen luminance to make the adjusted luminance located in the range in which human eyes are comfortable.

15. The electronic device according to claim 13, wherein in a case in which the luminance is not in the range in which human eyes are comfortable, adjusting the screen luminance comprises:
determining whether the luminance is too dark or too bright; and
in a case in which the luminance is too dark, increasing the screen luminance until the luminance corresponding to the detected pupil size is in the range in which human eyes are comfortable; or
in a case in which the luminance is too bright, reducing the screen luminance until the luminance corresponding to the detected pupil size is in the range in which human eyes are comfortable.

16. The electronic device according to claim 13, wherein after the screen luminance is adjusted, the method further comprises:
receiving an instruction of the user for adjusting the screen luminance; and
according to the instruction of the user for adjusting the screen luminance, adjusting the screen luminance.

17. The electronic device according to claim 13, wherein the electronic device further comprises:
associating the screen luminance adjusted according to the instruction of the user for adjusting the screen luminance with an initially detected pupil size, and storing same.

18. The electronic device according to claim 13, wherein the adjusting the screen luminance according to the pupil size comprises:
in a case in which the detected pupil size is same as the pupil size on which associative storage is performed, adjusting the screen luminance to the screen luminance on which associative storage is performed.
